(19) United States
(12) Patent Application Publication
(10) Pub. No.: US 2007/0208463 A1
(43) Pub. Date: Sep. 6, 2007

(54) Learning a predicted voltage to supply an electronic device based on dynamic voltage variation

(75) Inventors: Gerald Keith Bartley, Rochester, MN (US); Moises Cases, Austin, TX (US); Daniel N. de Araujo, Cedar Park, TX (US); Mark Owen Maxson, Mantorville, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/366,881

(22) Filed: Mar. 2, 2006

(51) Int. Cl. G05D 11/00

(52) U.S. Cl. 700/291

(57) ABSTRACT

In an embodiment, a predicted voltage to supply to an electronic device is learned based on a dynamic voltage variation that occurs at the electronic device. The dynamic voltage variation occurs in response to the electronic device processing a functional event, and the predicted voltage is supplied to the electronic device in response to observing the functional event on a bus that is connected to the electronic device. In response to observing the dynamic voltage variation, the predicted voltage that is associated with the functional event is modified based on the dynamic voltage variation. Then, on the next occurrence of the functional event, the predicted voltage is supplied to the electronic device. In this way, voltage transients at the electronic device are controlled.

### CROSS-REFERENCE TO RELATED APPLICATIONS

The present application is related to commonly-assigned patent application Ser. No. 11/186,607, to John J. Stecher et al., filed Jul. 21, 2005, entitled “Server Power Management,” which is herein incorporated by reference.

### FIELD

An embodiment of the invention generally relates to computers. In particular, an embodiment of the invention generally relates to adjusting the voltage supplied to an electronic device based on dynamic voltage variation.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware components (such as processors, memory, storage devices, semiconductors, integrated circuits, programmable logic devices, programmable gate arrays, and circuit boards) and software, also known as computer programs.

The hardware components require electrical current to operate, which is supplied by a power supply via a voltage regulator. A traditional technique of managing the voltage for a series of components involves placing a sense point connected to a feedback path to the voltage regulator, which allows the regulator to respond to voltage variations caused, for the most part, by current demand transients. But, voltage variations may also result from component differences that occur from lot-to-lot, chip-to-chip, system-to-system, or from end-of-life wear out effects.

Another technique, usually used for single-component regulators such as those used on processors, utilizes the concept of a load-line to determine the set point for the voltage. The more current being sourced, the more dc-voltage drop assumed, and thus the regulator raises the voltage at its output pins in an attempt to compensate. These techniques, and others like them, suffer from the problem that they are primarily reactive by nature and can only control the voltage at the component within a time constant. Thus, these reactive techniques force the component to be capable of operating over a large variation in voltage. Further, these reactive techniques do not allow the component or system designer to optimize power around either performance or power dissipation.

The problems of these reactive techniques are exacerbated by components that typically receive functional mode transitions that result in large power demand variations. For example, the power that a processor requires to perform a floating-point multiply instruction may be considerably larger than the power that the processor requires to perform an addition instruction. These power demand variations account for very large current transitions, which in turn, create large voltage transitions proportional to the impedance of the power distribution network.

Consequently, there is a need for an enhanced technique that provides tighter control on voltage transients and allows for the optimization of a nominal voltage setpoint, which leads to increased performance and/or lower power consumption.

### SUMMARY

A method, apparatus, system, and signal-bearing medium are provided. In an embodiment, a predicted voltage to supply to an electronic device is learned based on a dynamic voltage variation that occurs at the electronic device. The dynamic voltage variation occurs in response to the electronic device processing a functional event, and the predicted voltage is supplied to the electronic device in response to observing the functional event on a bus that is connected to the electronic device. In response to observing the dynamic voltage variation, the predicted voltage that is associated with the functional event is modified based on the dynamic voltage variation. Then, on the next occurrence of the functional event, the predicted voltage is supplied to the electronic device. In this way, voltage transients at the electronic device are controlled.

### BRIEF DESCRIPTION OF THE DRAWING

FIG. 1 depicts a block diagram of an example system for implementing an embodiment of the invention.

FIG. 2 depicts a block diagram of an example data structure for a stored voltage setting repository, according to an embodiment of the invention.

FIG. 3 depicts a flowchart of example processing for adjusting voltage to an electronic device, according to an embodiment of the invention.

### DETAILED DESCRIPTION

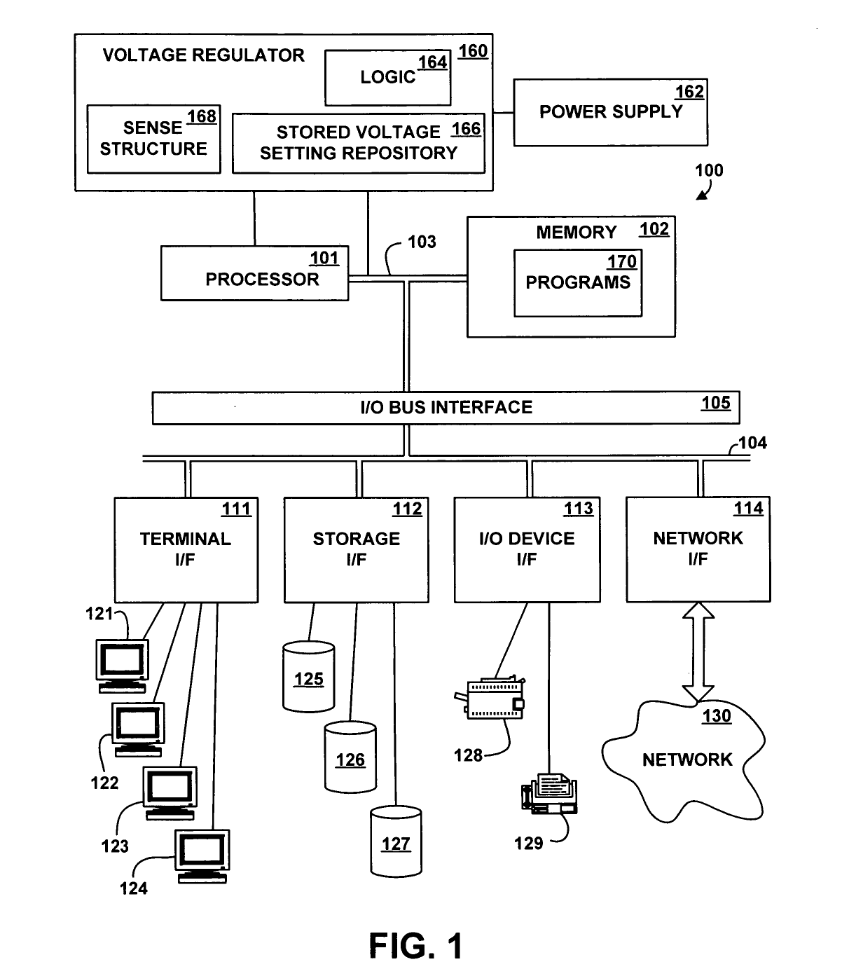

Referring to the Drawings, wherein like numbers denote like parts throughout the several views, FIG. 1 depicts a high-level block diagram representation of a computer system 100 connected to a network 130, according to an embodiment of the present invention. The major components of the computer system 100 include one or more processors 101, a main memory 102, a terminal interface 111, a storage interface 112, an I/O (Input/Output) device interface 113, communications/network interfaces 114, and a voltage regulator 160, all of which are coupled for inter-component communication via a memory bus 103, an I/O bus 104, and an I/O bus interface unit 105.

The computer system 100 contains one or more general-purpose programmable processors 101. In an embodiment, the computer system 100 contains multiple processors typical of a relatively large system; however, in another embodiment the computer system 100 may alternatively be a single CPU (Central Processing Unit) system. Each processor 101 executes instructions or programs 170 stored in the main memory 102 and may include one or more levels of hierarchical memory or cache.

The main memory 102 is a random-access semiconductor memory for storing data and programs. The main memory 102 is conceptually a single monolithic entity, but in other embodiments, the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes programs 170 that include instructions capable of being sent to the processor 101 via the memory bus 103 for execution. Although the programs 170 are illustrated as being contained within the memory 102 in the computer system 100, in other embodiments they may be on different computer systems and may be accessed remotely, e.g., via the network 130. The computer system 100 may use virtual addressing mechanisms that allow the programs 170 of the computer system 100 to behave as if they only have access to a large, single storage entity instead of access to multiple, smaller storage entities. Thus, while the programs 170 are illustrated as being contained within the memory 102 in the computer system 100, these elements are not necessarily all completely contained in the same storage device at the same time.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be loaded from and stored to the memory 102 as needed.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types.

The network interface 114 provides one or more communications paths from the computer system 100 to other digital devices and computer systems; such paths may include, e.g., one or more networks 130. In various embodiments, the network interface 114 may be implemented via a modem, a LAN (Local Area Network) card, a virtual LAN card, or any other appropriate network interface or combination of network interfaces.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a firewall, router, Internet Service Provider (ISP), personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The voltage regulator 160 is connected to a power supply 162, the processor 101, and the memory bus 103, but in various other embodiments the voltage regulator 160 may be connected to any appropriate bus and any appropriate electronic device. Examples of buses include, but are not limited to, the memory bus 103 and the I/O bus 104. Examples of electronic devices include, but are not limited to, the processor 101, the memory 102, the I/O bus interface 105, the terminal interface 111, the storage interface 112, the I/O device interface 113, the network interface 114, the terminals 121, 122, 123, or 124, the storage devices 125, 126, or 127, the printer 128, the fax machine 129, or any portion, multiple, or combination thereof.

The voltage regulator 160 supplies electrical current from the power supply 162 to the electronic device and regulates the voltage of the supplied electrical current. The voltage regulator 160 includes logic 164, a stored voltage setting repository 166, and a sense structure 168.

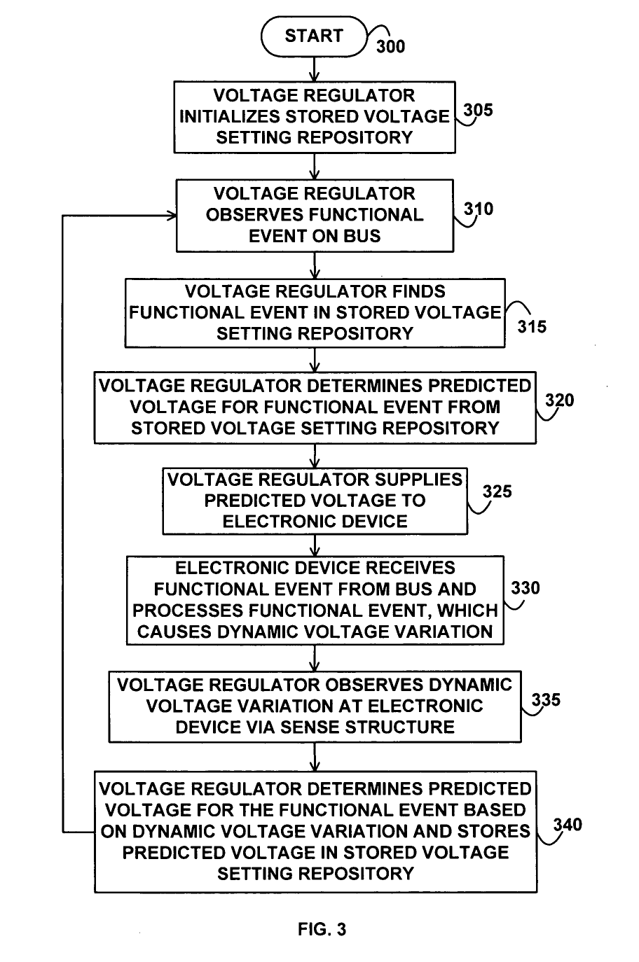

In various embodiments, the logic 164, or any portion thereof, may be centralized at the voltage regulator 160 or distributed. In an embodiment, the logic 164 includes instructions and a general-purpose or special-purpose processor capable of executing the instructions to perform the functions as further described below with reference to FIG. 3. In another embodiment, the logic 164 may be implemented in microcode. In another embodiment, the logic 164 may be implemented in hardware via logic gates and/or other appropriate hardware techniques in lieu of or in addition to a processor-based voltage regulator.

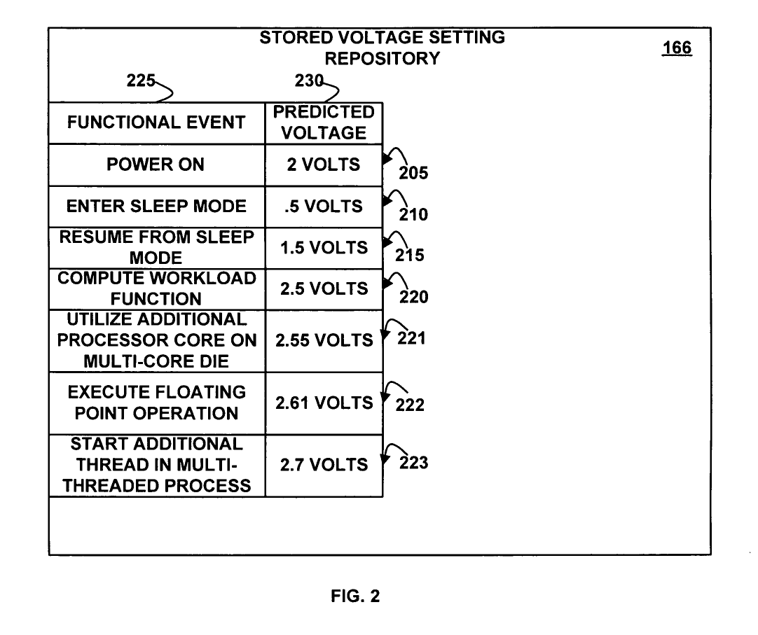

The stored voltage setting repository 166 includes voltage settings for electronic devices associated with various functional events that the voltage regulator may observe on the bus. The functional events may be sent on any bus between any appropriate electronic devices (e.g., the bus 103 or 104). For example, a functional event may be an instruction sent from the programs 170 in the memory 102 to the processor 101 via the bus 103, or a functional event may be a command and/or data sent from the processor 101 to the terminal interface 111, the storage interface 112, the I/O device interface 113, and/or the network interface 114 via the I/O bus 104. The stored voltage setting repository 166 is further described below with reference to FIG. 2.

The sense structure 168 senses the dynamic voltage variation at the electronic device, e.g., the processor 101 or any other electronic device. The dynamic voltage variation is the loss in output voltage from the electronic device as the input voltage to the electronic device drives the impedance of the distribution system of the electronic device. The dynamic voltage variation occurs because of a reduction in the operating voltage of the electronic device due to an increased current draw over a short period of time (a current surge), which causes a droop in voltage that is proportional to the impedance of the electronic device. Dynamic voltage variations may cause delays in circuit operation and may cause a circuit to operate at a lower frequency than it could support if the frequency were based on the average voltage of operation. Although the sense structure 168 is illustrated as contained within the voltage regulator 160, in another embodiment, the sense structure 168 may be distributed on die at a particular circuit or globally at a chip, package, card, or any other appropriate electronic device.

It should be understood that FIG. 1 is intended to depict the representative major components of the computer system 100 and the network 130 at a high level, that individual components may have complexity greater than represented in FIG. 1, that components other than, fewer than, or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors of the logic 164 in the computer system 100, cause the computer system 100 to perform the steps necessary to execute steps or elements embodying the various aspects of an embodiment of the invention. In another embodiment, traditional software functions may be implemented in hardware.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of tangible signal-bearing media that may be operatively or communicatively connected (directly or indirectly) to the logic 164 of the voltage regulator 160. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), CD-RW, or diskette; or

(3) information conveyed to the computer system 100 by a communications medium, such as through a computer or a telephone network, e.g., the network 130, including wireless communications.

Such tangible signal-bearing media, when encoded with or carrying computer-readable and executable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example data structure for a stored voltage setting repository 166, according to an embodiment of the invention. The stored voltage setting repository 166 includes example records 205, 210, 215, 220, 221, 222, and 223, each of which includes a functional event field 225, and a predicted voltage field 230. In various embodiments, the functional event 225 may identify an instruction, a command, a data transfer, or any other functional event capable of being received by an electronic device via a bus, the receipt of which causes the electronic device to perform a function. The predicted voltage field 230 identifies the amount of voltage that the voltage regulator 160 is to provide to the electronic device that receives the respective functional event 225. In other embodiments, the predicted voltage field 230 may include any other appropriate information, such as the response curve, the minimum and/or maximum dynamic voltage variation, and/or the minimum and/or maximum overshoot. The stored voltage setting repository 166 may be customized for a particular electronic device or a particular computer system 100.

For example, record 205 indicates that in response to observing the “power on” functional event 225 on a bus, the voltage regulator 160 is to supply 2 volts to the electronic device; record 210 indicates that in response to observing the “enter sleep mode” functional event 225 on a bus, the voltage regulator 160 is to supply 0.5 volts to the electronic device; record 215 indicates that in response to observing the “resume from sleep mode” functional event 225 on a bus, the voltage regulator 160 is to supply 1.5 volts to the electronic device; record 220 indicates that in response to observing the “compute workload function” functional event 225 on a bus, the voltage regulator 160 is to supply 2.5 volts to the electronic device; record 221 indicates that in response to observing the “utilize additional processor core on multi-core die” functional event 225 on a bus, the voltage regulator 160 is to supply 2.55 volts to the electronic device; record 222 indicates that in response to observing the “execute floating point operation” functional event 225 on a bus, the voltage regulator 160 is to supply 2.61 volts to the electronic device; record 223 indicates that in response to observing the “start additional thread in multi-threaded process” functional event 225 on a bus, the voltage regulator 160 is to supply 2.7 volts to the electronic device. The data illustrated in FIG. 2 is exemplary only, and in other embodiments any number and type of functional events or amounts of voltage may be used.

FIG. 3 depicts a flowchart of example processing for adjusting voltage to a device, or subset of the device, according to an embodiment of the invention. Control begins at block 300. Controlled and continues to block 305 where the voltage regulator 160 initializes the data of the stored voltage setting repository 166 by storing initial predicted voltages 230 for the functional events 225 into the records of the stored voltage setting repository 166. The voltage regulator 160 may receive the initial values via the memory bus 103, the initial values may be set by the designer of the voltage regulator 160, or the initial values may be determined via any appropriate technique.

Control then continues to block 310 where the voltage regulator 160 observes a functional event on a bus, such as the memory bus 103 or the I/O bus 104, prior to the electronic device receiving and processing the functional event. In various embodiments, a functional event may be an instruction, a command, a data transfer, or any other functional event capable of being received from a bus and processed by an electronic device.

Control then continues to block 315 where the voltage regulator 160 finds the observed functional event 225 in a record of the storage voltage setting repository 166. Control then continues to block 320 where the voltage regulator 160 determines the associated predicted voltage 230 from the observed functional event 225 from the stored voltage setting repository 166. Control then continues to block 325 where the voltage regulator 160 supplies the determined predicted voltage 230 to the electronic device during the functional event, i.e., at the time that the electronic device is receiving and processing the functional event. Control then continues to block 330 where the electronic device receives the functional event from the bus and processes the functional event, which causes dynamic voltage variation. Control then continues to block 335 where the voltage regulator 160 observes the dynamic voltage variation at the electronic device via the sense structure 168.

Control then continues to block 340 where the voltage regulator 160 determines the predicted voltage for the functional event based on the observed dynamic voltage variation and stores the predicted voltage in the stored voltage setting repository 166. The voltage regulator 160 modifies the predicted voltage 230 in the stored voltage setting repository 166 for the observed functional event 225 based on the observed dynamic voltage variation. For example, in an embodiment, the voltage regulator 160 may add the observed dynamic voltage variation to the existing predicted voltage 230 to create a resultant new predicted voltage 230. The voltage regulator 160 then uses the resultant new predicted voltage 230 on the next occurrence of the functional event, i.e., the next time that functional event is observed on the bus. Thus, the voltage regulator has learned the predicted voltage to supply the electronic device for the functional event, and this learning is based on the dynamic voltage variation that occurs at the electronic device in response to the electronic device processing the functional event.

Control then returns to block 310 where the voltage regulator 160 observes another functional event on the bus, as previously described above. Thus, the voltage regulator 160 repeats the observing, finding, determining, supplying, receiving, observing, and determining elements of blocks 310, 315, 320, 325, 330, 335, and 340, respectively.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
learning a predicted voltage to supply an electronic device during a functional event, wherein the learning is based on a dynamic voltage variation, wherein the dynamic voltage variation occurs at the electronic device in response to the electronic device processing the functional event.

2. The method of claim 1, wherein the learning further comprises:
observing the functional event;
determining the predicted voltage that is associated with the functional event; and
supplying the predicted voltage to the electronic device, wherein the electronic device is to receive the functional event.

3. The method of claim 2, wherein the learning further comprises:
observing a dynamic voltage variation at the electronic device; and
determining the predicted voltage that is associated with the functional event based on the dynamic voltage variation; and
storing the predicted voltage.

4. The method of claim 3, wherein the learning further comprises:
repeating the observing the functional event on a next occurrence of the functional event; and
repeating the determining the predicted voltage based on an output of the modifying the predicted voltage.

5. The method of claim 3, wherein the observing the dynamic voltage variation further comprises:
observing the dynamic voltage variation in response to the electronic device processing the functional event.

6. The method of claim 2, wherein the observing the functional event further comprises:
observing the functional event on a bus that is connected to the electronic device prior to the electronic device receiving the functional event from the bus.

7. The method of claim 1, wherein the functional event comprises an instruction directed to the electronic device.

8. The method of claim 1, wherein the electronic device comprises a processor.

9. The method of claim 1, further comprising:
initializing a repository for a plurality of functional events and a corresponding plurality of predicted voltages.

10. A signal-bearing medium encoded with instructions, wherein the instructions when executed comprise:
learning a predicted voltage to supply an electronic device during a functional event based on a dynamic voltage variation that occurs at the electronic device in response to the electronic device processing the functional event, wherein the learning further comprises
observing the functional event,
determining the predicted voltage that is associated with the functional event,
supplying the predicted voltage to the electronic device, wherein the electronic device is to receive the functional event,
observing a dynamic voltage variation at the electronic device, and
modifying the predicted voltage that is associated with the functional event based on the dynamic voltage variation.

11. The signal-bearing medium of claim 10, wherein the learning further comprises:
repeating the observing the functional event on a next occurrence of the functional event; and
repeating the determining the predicted voltage based on an output of the modifying.

12. The signal-bearing medium of claim 10, wherein the observing the dynamic voltage variation further comprises:
observing the dynamic voltage variation in response to the electronic device processing the functional event.

13. The signal-bearing medium of claim 10, wherein the observing the functional event further comprises:
observing the functional event on a bus that is connected to the electronic device prior to the electronic device receiving the functional event from the bus.

14. The signal-bearing medium of claim 10, wherein the functional event comprises an instruction directed to the electronic device.

15. The signal-bearing medium of claim 10, wherein the electronic device comprises a processor.

16. The signal-bearing medium of claim 10, wherein the learning further comprises:
initializing a repository for a plurality of functional events and a corresponding plurality of predicted voltages.

17. A computer system comprising:
a processor connected to a bus; and
a voltage regulator connected to the processor and the bus, wherein the voltage regulator learns a predicted voltage to supply the processor during a functional event based on a dynamic voltage variation that occurs at the processor in response to the processor processing the functional event, wherein the voltage regulator further observes the functional event on the bus, determines the predicted voltage that is associated with the functional event, supplies the predicted voltage to the processor, observes a dynamic voltage variation at the processor, and modifies the predicted voltage that is associated with the functional event based on the dynamic voltage variation.

18. The computer system of claim 17, wherein the voltage regulator repeatedly observes the functional event and repeatedly determines the predicted voltage based on an output of the modification of the predicted voltage.

19. The computer system of claim 17, wherein the voltage regulator observes the functional event on the bus prior to the processor processing the functional event from the bus.

20. The computer system of claim 17, wherein the voltage regulator initializes a repository for a plurality of functional events and a corresponding plurality of predicted voltages.
